(19) United States
(12) Patent Application Publication
(10) Pub. No.: US 2007/0201061 A1
(43) Pub. Date: Aug. 30, 2007

(54) COLOR MANAGEMENT OF DIGITAL FILES AND IMAGES FOR PRINTING

(76) Inventor: Ernest Daniel Miller, Portland, OR (US)

Correspondence Address: STOEL RIVES LLP, 900 SW FIFTH AVENUE, SUITE 2600, PORTLAND, OR, 97204-1268, US

(21) Appl. No.: 11/680,424

(22) Filed: Feb. 28, 2007

Related U.S. Application Data
(60) Provisional application No. 60/778,084, filed on Feb. 28, 2006.

(51) Int. Cl. G06F 15/00

(52) U.S. Cl. 358/1.9

(57) ABSTRACT

A color management method using software, hardware, and methodology to control, to quantify and to compensate for printing device variability, including optimizing the range of colors a device is able to reproduce, that is, the device's color gamut. This methodology is useful for a plurality of printing machines and becomes an integral component of the print production process between the author/creator of the print project and the fulfillment print vendor. By means of an analytical color model used to predict the print production behavior, this color management system optimizes the printing device's reproductive gamut thereby improving the appearance of printed materials in relation to other electronic media and display devices. In the process of meeting this objective, the color accuracy and automation of this color management system eliminates hours of manual retouching by color correction specialists and prepress experts.

### RELATED APPLICATIONS

This application claims priority from U.S. Provisional Application No. 60/778,084, filed Feb. 28, 2006, incorporated herein by reference as though fully set forth.

### COPYRIGHT NOTICE

© 2006-2007 Ernest Miller. Portions of the disclosure of this patent document, including the Appendices, contain material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR § 1.71 (d).

### TECHNICAL FIELD

This invention in the field of printing relates generally to digital printing, commercial sheet-fed lithography, heat-set web lithography, cold-set web lithography, rotogravure processes, flexography, and other print related processes. The subject printed materials relate to document printing, print advertising, print packaging and printed containers, book publishing, magazine publishing, art reproduction, and related printed products. The invention relates, in particular, to the color management and color transformation of color digital images and files from one color space, for example raw binary code, RGB bitmaps, or L*a*b color to another, for example, 1, 2, 4, 6 or multiple color printing environments from original image capture to color management and presentation to the printing device for processing and manufacture.

### BACKGROUND

With the introduction of computer technology, in the early 1990's, founding members formed the International Color Consortium (ICC), a worldwide regulatory body that supervises color management protocols between software vendors, equipment manufacturers, and users. Today's color management is basically and universally “ICC Color Management”. The problem lies in specifying the color and tone reproduction expected. Recognizing that controlling color in an imaging and publication chain is difficult and largely impractical, the ICC charged with the purpose of creating, promoting, and encouraging the standardization and evolution of an open, vendor-neutral, cross-platform, universal color management system architecture and components proposed the concept of ICC Color Management.

The ICC Color Management solution introduces an intermediate representation of desired colors and tone values called the profile connection space or PCS. The role of the PCS is to serve as the hub for all device-to-device transformation in the publication chain. The components of ICC Color Management are the PCS, Profiles that describe the relationship between a device's control signals and the actual color that those signals produce; CMM, the color management module or color engine, that is, software that performs the interpolation between one device and another, and Rendering Intents that compensate for colors that cannot be physically reproduced by one of the devices in the imaging and publishing chain.

Color is a result of interactions between light sources, physical objects, and the human visual system. The color management challenge begins with modeling the complex and variable nature of these physical and psychological effects. Reproducing color in the digital domain poses additional challenges. In today's open computing environment, constraints are imposed by differing capabilities and closed-source technologies in devices, device drivers, applications, operating systems, and networks.

In sum, the different ICC color-management components combine to assign a specific color meaning to RGB and CMYK (n) numbers and then to change the RGB or CMYK (n) numbers as the publication images and files move from device to device to ensure that the actual color remains constant. The recommended ICC architecture accomplishes color management by embedding a profile, essentially a color descriptive look-up table (LUT), into the original image file and then converting the file with its assigned profile through the CMM to a chosen output destination profile describing the new output device color space.

The ICC architecture and technical specifications do not distinguish between a digital printing device, such as an inkjet printer, laser printer, or monitor and analog printing devices such as lithographic, flexography, or gravure presses. Moreover, the ICC does not define device-dependant color gamut working spaces such as RGB and CMYK, but rather, the ICC model is to map device-dependant RGB/CMYK through the PCS or device-independent LAB or XYZ. The lack of specifications for device-dependant working spaces and the fact that the idealized PCS connection space is not numerically quantified, are systemic problems associated with ICC-based color management solutions. The need thus remains for improvements in color management of digital files and images for printing.

Additional aspects and advantages will be apparent from the following detailed description of preferred embodiments, which proceeds with reference to the accompanying drawings and appendices.

### BRIEF DESCRIPTION OF THE DRAWINGS

FIG. 1 is a simplified block diagram of ICC color management architecture. The ICC provides for a common, open interface for transforming color data between different devices and media and recommends the color management architecture implied by the specifications of the ICC profile format and its reference color space (PCS).

FIG. 2 illustrates the addition of a theoretical or an analytic mathematical color model. Traditionally, an empirical process determines the behavior of the printing device. An empirical process, ordinarily an accurate prediction of device behavior, blends distinct multi-color channels into to a single color map. Once printed, it is no longer possible to trace individual channel performance to the original input data. For example, it is impossible to tell if a hue, chroma, or luminosity error can be attributed to a particular condition. By adding the feature of an analytical model to the color management process, device behavior can be separated from input data and an error traced and corrections made.

FIG. 3 illustrates P*RGB space RGB color space is device dependent, however, there are many models used to contour control signals.

FIG. 4 is an LAB Normalized Training Set. An analytical model uses CMYK addresses calibrated to the printing device or calibrated to the PCS device-independent space. FIG. 4 is an example of data calibrated to human perceptual vision as defined by CIELAB.

FIG. 5 illustrates a 2-D and 3-D an analytical mathematical model of color space. The traditional volume addresses between 500,000 to 650,000 discrete color coordinates. The analytical model expands the volume to include up to 1.8 million color addresses.

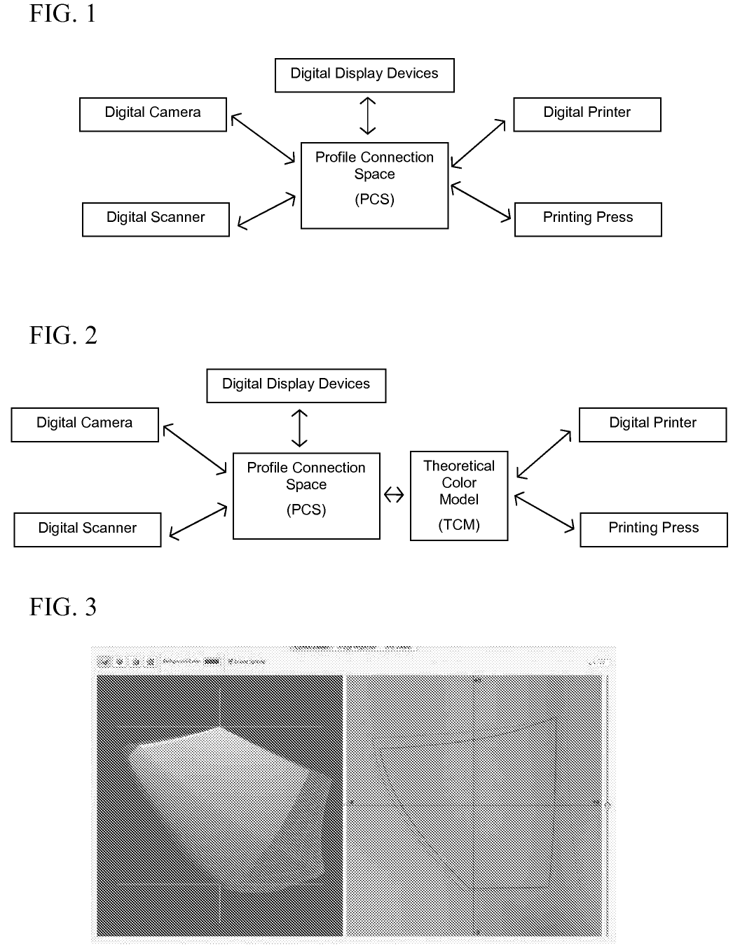

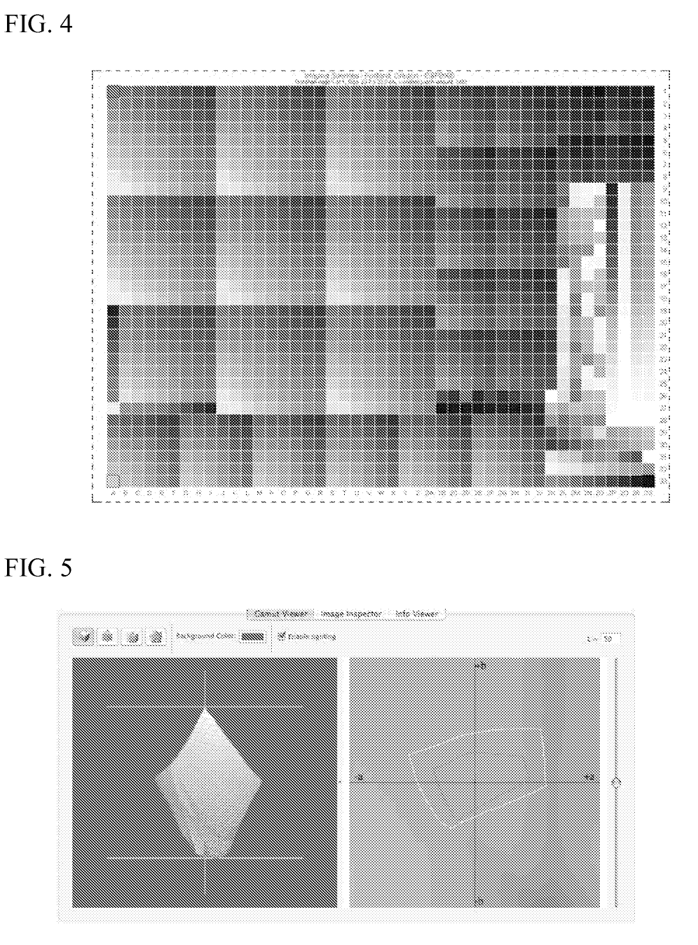

### BRIEF DESCRIPTION OF THE APPENDICES

Appendix 1 is an analytical model data table for improved color management.

Appendix 2 is a colorant model data table for improved color management that shares a parent/sibling relationship with the Analytical Model as reflected in Appendix 1 in accordance with the illustrative embodiment.

Appendix 3 is an input data table in accordance with the illustrative embodiment.

Appendix 4 are output tables in accordance with the illustrative embodiment.

### DETAILED DESCRIPTION OF PREFERRED EMBODIMENTS

In contrast to prior art, the objective of this invention is to provide an improved method for managing color requirements in the digital domain that the author/creator intends for printed publication.

The present disclosure in one aspect includes a P*RGB (Print Star RGB) editing space to carry out author's alterations to image files generated by illustration software or with digital photographic cameras or scanners. P*RGB differs from conventional RGB spaces (e.g., sRGB, scRGB, Adobe RGB (1998), Apple RGB) in its gamut, which comprises a position of primary colors (RGB) respectively at L*a*b coordinates of R=[49, 68, 53]; G=[52, −71, 30]; and B=[26, 27, −50] when the Black Point is L*a*b [0,0,0] as an example in one embodiment of device reproducibility of colorants. In so doing, trained professionals can readily execute elective author's alterations without compromising Tone Reproduction, Gray Balance, and Black Point. In this way, the invention supports RGB workflows that are otherwise difficult to implement in print production.

The present disclosure also includes a new method for describing the range of colors a device can produce. In one embodiment, some devices create colors in cyan, magenta, yellow, and black (CMYK). In the case of a printing press, ICC compliant architecture anticipate a method of describing the printable range of colors by printing a standard Training Set (IT8.7/3,IT8.7/4, and ECI 2000) and then recording the printed result with a spectrophotometer with L*a*b or XYZ values. This data set becomes the physical reference for the output ICC Profile.

This data set represents device behavior, that is, it fairly reflects how the device reproduced the stimuli from the digital file. However, this empirical data set does not linearly reflect the original image stimulus. Because of the non-linear difference between input and output, the ICC Profile directly equates the device reproduction with the stimuli and substitutes post production data (empirical behavior) for pre-production data (digital stimulus) compromising and reducing the device's range of colors.

The present invention addresses this problem by creating the device profile from an analytical mathematical model. In this way, the profile presents to the printing device an optimized data stream, which in turn optimizes the range of colors the device can reproduce. In other words, a new mathematical model developed by the present inventor is used to generate the practical data to form improved device profiles which, in turn, can be used for improved printing of actual physical output.

Specifically by using an analytical model, the data coordinates representing the device color gamut describes an expanded color gamut, for example, a wide-gamut CMYK. The analytical model achieves a greater printing gamut by describing achromatic values that replace gray component accumulation with a calculated combination of primary colors and black. This selective use of gray component replacement expands the printable gamut as defined by ICC profiles by a factor of 2.

In one embodiment, the present invention also includes a method of adjusting the Training Set input stimuli to evenly apportion perceptually uniform color values in LAB color space in addition to print centric CMYK values. By using an analytical model with L*a*b linearity, the profiling process can anticipate print anomalies and systemic noise to generate Training Set targets with modified CMYK values resulting in uniform distribution of LAB values.

FIG. 3 illustrates P*RGB space RGB color space is device dependent, however, there are many models used to contour control signals. In effect, these signals spray streams of electrons striking and exciting phosphors and by varying the strength of the electron stream the phosphors emit more or less of a specific color. In CRT display systems, the relationship between input voltage and output luminance is gamma. Gamma is the degree to which a device or color space is non-linear in tone behavior. However, it is well known that traditional gamma, between 1.8 and 2.2 is exceptionally non-linear in dark to mid-tones. An analytical model can compensate for this on-linearity and improve tone and color reproduction. FIG. 3 shows how the destination color space can be matched to the input color space.

Other features of the invention embody perceptually uniform LAB values that correct for known deficits in color accuracy of nonspectral hues between violet at 400 nm to red at 700 nm. The analytical mathematical model [02.] assigns color values that, where deficient, adjust LAB coordinates with LCh cylindrical coordinates to improve accuracy between the RGB data and the transformed print values, often CMYK values.

There are four data tables attached and described below that, in concert, define the relationship between an input image, for example an RGB or JPEG, and the desired output behavior of the reflective printing device in accordance with an illustrative embodiment of one aspect of the present invention. The structure of the appended tables comply with international standards as set forth by the ICC (International Color Commission) thereby enabling an open-interface with a plurality of operating systems and requisite applications.

### DISCUSSION OF THE APPENDICES

Appendix 1—Analytical Model
This table represents data mathematically derived, the old methodology derives data coordinates from an empirical model.
This data defines a new color space wherein scalar coordinates minimize compression from large to smaller color volumes.
This table represents the SWOP reference printing standard, one of multiple characterizations which may include:
   A table representing data populated in a different domain such as CIELAB with different linearization attributes,
   Or, a table representing different print reference standards such as GRACOL, FOGRA, or SNAP,
   Or, a table representing imaging capabilities of existing digital technologies,
   Or, a table representing emerging technologies in reflective imaging.
   Or, a table representing multiple colorants including 1, 2, 4, 6, 7, 12, and Pantone Hexachrome color combinations. Typical range is 1 to 24.
   Or, a table with more or less color addresses.

Appendix 2—Colorant Model
This table shares a parent/sibling relationship with the Analytical Model.
The Colorant Model is a tensor product of univariate splines and linear regression methods, which establishes the colorant to device-independent relationship.
This table is an inverse model and is calculated from a forward model. In some workflows, the forward model is not used to generate the RGB-to-CMYK transform and is therefore not represented.
This table represents the SWOP reference printing standard, one of multiple models used in practice. Other iterations may include:
   Colorimetric and saturation rendering intents.
   A plurality of reference standards common in commercial printing.
   A plurality of existing and emerging digital imaging technologies.
   A range of colorants from 1 to 24 distinct formulations including 1, 2, 4, 6, 7, 12, and Pantone Hexachrome color combinations.
   A model with more or less interpolation nodes.

Appendix 3—Input Tables
These tables represent X/Y functions, essentially linearization curves that pre-condition the input data for processing.
The input data filtered by these tables can be XYZ or CIELAB or any similar space as long as the data is scalar in 8 to 64-bit density.
These tables are calibrated to industry standard RGB spaces. Specifically this table is calibrated to Adobe1998RGB. Other RGB spaces may include, but are not limited to:
   sRGB
   ProPhotoRGB
   MatchColor RGB
The data in this table is derived from piecewise polynomials.

Appendix 4—Output Tables
These tables comprise X/Y functions and condition the CMYK data for printing by specific printing devices.
These data tables filter data from 8 to 64-bit densities.
This table is calibrated to SWOP reference standards. Other standards may include
   SNAP, FOGRA, GRACOL, JAFTA, Pantone Hexachrome Epson, Canon, HP, KODAK, Agfa, and other popular printing devices.
   Printing plant or device specific print conditions.

Combining Tables
Tables arrays and models may be combined to form a plurality of color addresses.
Tables and models can be used in combination with other ICC compliant tables defined by the ICC architecture.

It will be obvious to those having skill in the art that many changes may be made to the details of the above-described embodiments without departing from the underlying principles of the invention. The scope of the present invention should, therefore, be determined only by the following claims.

1. A method of managing color comprising a method for improving the printable gamut and color accuracy of imaging devices, that:
Embodies a new editing P*RGB color space;
Defines color reproduction as an analytical mathematical model;
Expands the known reproductive color gamut of imaging devices;
Identifies color in LAB and LCh to correct known display errors;
Calculates color placement uniformly perceptual to a human observer;
Said methods of managing color are useful in ICC and other system architectures.

2. The method of managing color as claimed in claim 1, wherein said P*RGB space positions primary and tertiary colors relative to the Black Point.

3. The method of managing color as claimed in claim 1, wherein said P*RGB facilities author correction to image files by minimizing Tone Reproduction and Gray Balance compromises.

4. The method of managing color as claimed in claim 1, wherein an analytical mathematical model of device capabilities replaces current state-of-art postproduction or empirical devised data sets.

5. A Training Set design for use in color management that specifies a distribution of LAB values in addition to print-centric values such as CMYK; wherein
the Training Set provides the source document for calculating an ICC complaint Profile; and
the Training Set comprises a unique array of psychological colors to facilitate color compliance as expected by a standard human observer.

6. The Training Set design as claimed in claim 5, wherein said Training Set can represent both LAB and LCh values.
